(19) United States
(12) Patent Application Publication
(10) Pub. No.: US 2010/0280187 A1
(43) Pub. Date: Nov. 4, 2010

(54) REACTION INJECTION MOLDED POLYURETHANES MADE USING HIGH LEVELS OF NATURAL OIL-BASED POLYOLS

(76) Inventors: Mark G. Goldhawk, London (CA); Allan James, Oxford, MI (US); George A. Klumb, Novi, MI (US); Jack E. Hetzner, Reese, MI (US)

Correspondence Address: The Dow Chemical Company;GARY C. COHN, 215 E. 96TH STREET, APT# 19L, NEW YORK, NY, 10128, US

(21) Appl. No.: 12/675,954

(22) PCT Filed: Aug. 29, 2008
(86) PCT No.: PCT/US08/74776

§ 371 Date: Jul. 19, 2010

Related U.S. Application Data
(60) Provisional application No. 60/967,417, filed on Sep. 4, 2007.

(51) Int. Cl. C08G 71/04

(52) U.S. Cl. 525/454

(57) ABSTRACT

Polyurethane and/or polyurea polymers are produced in a reaction injection molding process. The high equivalent weight isocyanate-reactive materials include a high proportion of a hydroxymethylated polyester which can be prepared using annually renewable starting materials.

This application claims priority from U.S. Provisional Application No. 60/967,417, filed 4 Sep. 2007.

This invention relates to reaction injection molded polyurethane and/or polyurea polymers.

Reaction injection molding (RIM) is a process by which liquid resin precursor materials are brought together under conditions of high shear and then are immediately injected into a mold cavity, where they rapidly cure to form a molded, high molecular weight polymer. RIM processes are commonly used to produce polyurethane, polyurea, and polyurethane-urea molded articles such as automotive exterior parts like body panels, claddings and front and rear fascia. RIM processing is often favored when a short cycle time is needed and when large parts are prepared. RIM processing methods can be used to produce foam articles, but are most often used to produce mainly non-cellular, or, at most, microcellular parts. The densities of these parts are typically at least 0.6 g/cc and more commonly is at least 0.95 g/cc.

A polyurethane RIM formulation typically includes one or more high equivalent weight polyethers, at least one chain extender material and at least one polyisocyanate. The polyether is commonly a hydroxyl- or amine-terminated polymer of propylene oxide or copolymer of propylene oxide and ethylene oxide.

There is a growing interest in developing plastics materials that are increasingly based upon raw materials that are produced from annually renewable feedstocks. These new raw materials could substitute for existing materials that are produced from fossil fuels such as oil and natural gas. The cost and availability of oil and gas feedstocks is becoming increasingly volatile due to geopolitical factors, the development of large Asian economies, and the gradual depletion of global reserves of these materials. This trend is expected to continue throughout this century.

Vegetable oils and animal fats have been examined as potential replacement feedstocks. In the polyurethanes industry, alternative polyols have been developed, based on fatty acids obtained from vegetable oils. These have been described as substitutes for polyethers in various polyurethane systems. Castor oil has been used to produce polyurethanes in some systems. “Blown” vegetable oils as described in US Published Patent Applications 2002/0121328, 2002/0119321 and 2002/0090488 have been suggested for use in making various types of polyurethanes. In U.S. Pat. Nos. 4,423,162, 4,496,487 and 4,543,369, certain hydroxymethylated polyols as described as being useful for making various types of rigid polyurethanes.

More recently, a class of hydroxymethylated polyesters has been introduced as raw materials for polyurethanes. These hydroxymethylated polyesters have been described, for example, in WO 04/096882, WO 04/096883, WO 06/047432, WO 06/047431, WO 06/047434 and WO 06/118995. They are based on unsaturated fatty acids that are obtainable from various plant and animal sources. The primary commercial focus has been in flexible polyurethane slabstock foam, although some of the foregoing patent applications describe the use of the hydroxymethylated polyesters to make polyurethane dispersions, and polyurethane prepolymers which are useful in RIM applications. In RIM applications, using these prepolymers would permit only a small proportion of the polyol materials to be replaced, because by far the bulk of the polyols used in RIM formulations in on the “B” or polyol-side of the formulation.

The hydroxymethylated polyesters can be produced reasonably economically and have been found to have useful properties. However, in most applications, the amount of hydroxymethylated polyester that can be used has been limited. In most applications, only about 10-50% of the polyether that is used in a conventional polyurethane formulation can be replaced with the hydroxymethylated polyester. When more of the polyether is replaced, significant losses in the properties of the polyurethane are often seen. In other cases, difficulties in processing are experienced when high levels of the hydroxymethylated polyester are present. For these reasons, it has been necessary to use blends of the hydroxylmethylated polyester and a polyether in order to produce commercially acceptable polyurethane products. Therefore, the proportion of the polyurethane that is derived from annually renewable resources is increased, but not as much as it could be if more of the polyether could be replaced with the hydroxymethylated polyol.

Other polyols based on plant oils have been tried in RIM applications, but once again only a small proportion of the polyols have been replaced successfully. This is due in part to the unique demands that are placed on RIM systems. RIM systems are distinguished mainly by the very high reactivity of the systems, rigorous application performance requirements, and the need in many cases to produce parts that, when painted, have high quality surfaces similar to those that can be obtained with sheet metal. Process economics dictate that these systems must cure enough to be demolded in the space of 30 seconds or less from the time the polyol and isocyanate sides are contacted. The reactive components of a RIM system therefore must very reactive with each other. The system is usually catalyzed to further increase reaction speed. The fast reactivity that is needed, plus the fact that RIM parts tend to be rather large, require that the polyol and polyisocyanate sides be mixed and fully injected into the mold in a matter of five seconds or less, before the system begins to gel. Premature gelation can case aesthetic defects in the part, such as flow lines or underfilled sections.

In addition, the RIM system must be compatible with the auxiliary materials (such as internal mold release agents) and various fillers (typically short or medium-length fibers and/or a particulate filler such as mica) that are used in RIM systems. Internal mold release agents are almost always used to make it easier to pull the partially cured RIM polymer off the mold without becoming deformed and torn. The operation of these release agents depends on the ability to disperse them in the polyol and then throughout the polyurethane. The cured polymer must wet and adhere to filler materials in order to develop its physical properties. Because the fillers are often pre-blended into the polyol component, those fillers must be capable of being suspended in the polyol component.

The polyol side of a RIM system also must be capable of being “nucleated” by being blended with a small amount of a gas such as nitrogen.

In addition, the RIM-product must be paintable for many applications. The paint must adhere well to the surface of the RIM part and produce a high gloss with a good distinctness of image.

It would be desirable to provide a polyurethane RIM system that is produced from an increased proportion of raw materials that are based on annually renewable resources, provided that the RIM system meets the reactivity and other requirements of a polyurethane RIM process.

In one aspect, this invention is a reaction injection molding process comprising mixing a formulated polyol component with a polyisocyanate component, transferring the mixture to a closed mold and then curing the mixture in the mold to form a cured polyurethane and/or polyurea polymer, wherein the polyol component includes (1) at least one high equivalent weight material having at least 1.8 isocyanate-reactive groups per molecule and (2) at least one chain extender, and further wherein at least 40% by weight of the high equivalent weight material (1) is a hydroxymethylated polyester.

The hydroxymethylated polyester can be produced in part using annually renewable resources such as plant oils and animal fats, and so represent a way to produce the polyurethane and/or polyurea polymer using fewer non-renewable resources. Surprisingly, acceptable processing and physical property characteristics are maintained with the high level of the hydroxymethylated polyester in the formulation. The formulation processes quickly to permit short demold times that are needed in RIM processes to be used, while maintaining adequate green strength. Ultimate physical properties after full cure are sufficient for many applications such as automotive body panels, claddings and front and rear automotive fascia. The polyol component is compatible with internal mold release agents, fibers and fillers, and nucleates well.

In this invention a formulated polyol component is reacted with a polyisocyanate component in a closed mold to form a cured polymer. The polymer may contain urethane groups, or preferably both urethane and urea groups. For convenience, both of these types of polymers are referred to herein generally as “polyurethanes”. In describing this invention, the label “polyol component” is used for convenience to refer to a mixture of isocyanate-reactive materials that is reacted with the polyisocyanate component to form a polymer. As will become more apparent from the following description, the “polyol component” does not necessarily contain materials that have hydroxyl groups, although it will in most cases.

The polyol component includes at least one high equivalent weight material that has on average at least 1.8 isocyanate-reactive groups per molecule. Preferred isocyanate-reactive groups are hydroxyl, primary amino or secondary amino. Primary hydroxyl groups are especially preferred. The high equivalent weight material preferably has an average of at least 2.0, more preferably at least 2.5, isocyanate-reactive groups per molecule. It preferably does not have more than about 4.0 isocyanate-reactive groups per molecule and more preferably contains an average of up to 3.5 isocyanate-reactive groups per molecule.

The high equivalent weight material has an average weight per isocyanate group of at least 500, preferably at least 600 daltons, to about 4000, preferably to about 2500 and more preferably to about 1750 daltons.

At least 40% by weight of the high equivalent weight materials in the polyol component is one or more hydroxymethyl-containing polyester polyols. The hydroxymethyl-containing polyester polyol may constitute up to 100% by weight of the high equivalent weight materials. A preferred range is from 50 to 100%. A more preferred range is from 50 to 80%.

The hydroxymethyl-containing polyester polyol(s) have an average of at least 1.8, preferably at least 2.0, hydroxyl, primary and secondary amine groups combined per molecule. Primary hydroxyl groups are preferred. The hydroxymethyl group-containing polyester polyol(s) may have an average of up to 4 hydroxyl, primary and secondary amine groups combined per molecule, but preferably contains no more than about 3.5 such groups and even more preferably no more than about 3.0 such groups. The hydroxymethyl-containing polyester polyol(s) preferably have an equivalent weight of at least 500, preferably at least about 600, to about 4,000, preferably up to about 2,500, even more preferably up to about 1,750 daltons. Equivalent weight is equal to the number average molecular weight of the molecule divided by the combined number of hydroxyl, primary amine and secondary amine groups per molecule.

Hydroxymethyl-containing polyester polyols of this type are described in detail in WO 04/096882 and WO 04/096883. The hydroxymethyl-containing polyester polyol is conveniently prepared by reacting a hydroxymethyl group-containing fatty acid having from 12 to 26 carbon atoms, or an ester of such a hydroxymethyl group-containing fatty acid, with a polyol, hydroxylamine or polyamine initiator compound having an average of at least 2.0 hydroxyl, primary amine and/or secondary amine groups/molecule. Proportions of starting materials and reaction conditions are selected such that the resulting hydroxymethyl-containing polyester polyol contains an average of at least 1.3 repeating units derived from the hydroxymethyl-group containing fatty acid or ester thereof for each hydroxyl, primary amine and secondary amine group in the initiator compound, and the hydroxymethyl-containing polyester polyol has an equivalent weight as stated before.

The hydroxymethyl-containing polyester polyol advantageously is a mixture of compounds having the following average structure:

[H—X]_{(z-p)—R—[X—Z]}ₚ (I)

wherein R is the residue of an initiator compound having z hydroxyl and/or primary or secondary amine groups, where z is at least two; each X is independently —O—, —NH— or —NR′— in which R′ is an inertly substituted alkyl, aryl, cycloalkyl, or aralkyl group, p is a number from 1 to z representing the average number of [X—Z] groups per hydroxymethyl-containing polyester polyol molecule, Z is a linear or branched chain containing one or more A groups, provided that the average number of A groups per molecule is ≧1.3 times z, and each A is independently selected from the group consisting of A1, A2, A3, A4 and A5, provided that at least some A groups are A1, A2 or A3. A1 is:

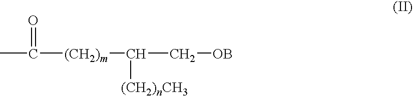

wherein B is H or a covalent bond to a carbonyl carbon atom of another A group; m is number greater than 3, n is greater than or equal to zero and m+n is from 8 to 22, especially from 11 to 19. A2 is:

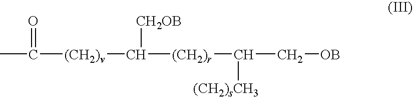

wherein B is as before, v is a number greater than 3, r and s are each numbers greater than or equal to zero with v+r+s being from 6 to 20, especially 10 to 18. A3 is:

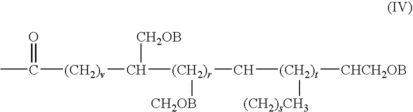

wherein B, v, each r and s are as defined before, t is a number greater than or equal to zero, and the sum of v, r, s and t is from 5 to 18, especially from 10 to 18. A4 is

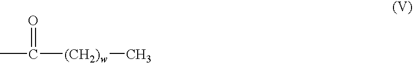

where w is from 10-24, and A5 is

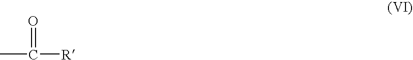

where R′ is a linear or branched alkyl group that is substituted with at least one cyclic ether group and optionally one or more hydroxyl groups or other ether groups. The cyclic ether group may be saturated or unsaturated and may contain other inert substitution. The hydroxyl groups may be on the alkyl chain or on the cyclic ether group, or both. The alkyl group may include a second terminal —C(O)— or —C(O)O— group through which it may bond to another initiator molecule. A5 groups in general are lactols, lactones, saturated or unsaturated cyclic ethers or dimers that are formed as impurities during the manufacture of the hydroxylmethyl-group containing fatty acid or ester. A5 groups may contain from 12 to 50 carbon atoms.

In formula I, n is preferably from 2 to 8, more preferably from 2 to 6, even more preferably from 2 to 5 and especially from about 3 to 5. Each X is preferably —O—. The total average number of A groups per hydroxymethylated polyester polyol molecule is preferably at least 1.3 times the value of z, such from about 1.3 to about 10 times the value of z, about 1.5 to about 10 times the value of z or from about 2 to about 5 times the value of z.

A is preferably A1, a mixture of A1 and A2, a mixture of A1 and A4, a mixture of A1, A2 and A4, a mixture of A1, A2 and A3, or a mixture of A1, A2, A3 and A4, in each case optionally containing a quantity of A5. Mixtures of A1 and A2 preferably contain A1 and A2 groups in a mole ratio of 10:90 to 95:5, particularly from 60:40 to 90:10. Mixtures of A1 and A4 preferably contain A1 and A4 groups in a mole ratio of 99.9:0.1 to 70:30, especially in a ratio of from 99.9:0.1 to 85:15. Mixtures of A1, A2 and A4 preferably contain from about 10 to 95 mole percent A1 groups, 5 to 90 percent A2 groups and up to about 30 percent A4 groups. More preferred mixtures of A1, A2 and A4 contain about 25-70 mole-% A1 groups, 15-40% A2 groups and up to 30% A4 groups. Mixtures of A1, A2 and A3 preferably contain from about 30-80 mole-% A1, from 10-60% A2 and from 0.1 to 10% A3 groups. Mixtures of A1, A2, A3 and A4 groups preferably contain from 20 to 50 mole percent A1, 1 to about 65 percent A2, from 0.1 to about 10 percent A3 and up to 30 percent A4 groups. Especially preferred polyester polyols of the invention contain a mixture of about 20-50% A1 groups, 20-50% A2 groups, 0.5 to 4% A3 groups and 15-30% A4 groups. In all cases, A5 groups advantageously constitute from 0-7%, especially from 0-5%, of all A groups.

Preferred mixtures of A groups conveniently contain an average of about 0.8 to about 1.5 —CH₂OH and/or —CH₂OB groups/A group, such as from about 0.9 to about 1.3 —CH₂OH and/or —CH₂OB groups/A group or from about 0.95 to about 1.2 —CH₂OH and/or —CH₂OB groups/A group. Such proportions of A groups (1) allow the initiator functionality to mainly determine the functionality the polyester polyol and (2) tend to form less densely branched polyester polyols.

“Inertly substituted” groups are groups that do not react with an isocyanate group and which do not otherwise engage in side reactions during the preparation of the hydroxymethyl-group containing polyester polyol. Examples of such inert substituents include aryl, cycloalkyl, silyl, halogen (especially fluorine, chlorine or bromine), nitro, ether, ester, and the like.

The R group in structure I is the residue of an initiator compound, after removal of hydroxyl, primary amino or secondary amino groups. A very wide range of initiator compounds can be used to form the hydroxymethyl-containing polyester polyol. The initiator, prior to removal of the terminal hydroxyl and amino groups, may have a weight of from 31 to 5000, from 100 to 3000, or from 300 to 2000, or from 300 to 1000 daltons. An initiator of particular interest is a linear or branched polyether having a weight of from 200 to 5000 daltons, from 300 to 3000 daltons, from 300 to 2000 daltons or from 100 to 1000 daltons. In such a case, R represents a linear or branched polyether. An especially preferred R group is a propylene oxide homopolymer, a copolymer of propylene oxide and up to 25% by weight ethylene oxide, or a poly(tetrahydrofuran).

The hydroxymethyl-containing polyester polyol generally contains some unreacted initiator compound, and may contain unreacted hydroxymethylated fatty acids (or esters). Initiator compounds often react only monofunctionally or difunctionally with the fatty acids (or esters), and the resulting polyester polyol often contains free hydroxyl or amino groups bonded directly to the residue of the initiator compound.

The hydroxymethyl-containing polyester polyol may be alkoxylated, if desired, to introduce polyether chains onto one or more of the hydroxymethyl groups. The hydroxymethyl-containing polyester polyol may also be aminated through reaction with ammonia or a primary amine, followed by hydrogenation, to replace the hydroxyl groups with primary or secondary amine groups. Primary or secondary amine groups can also be introduced by capping the polyester polyol with a diisocyanate, and then converting the terminal isocyanate groups so introduced to amino groups through reaction with water.

Up to 60% of the high equivalent weight materials in the polyol component may be a different material (i.e., not a hydroxymethylated polyester polyol). This additional high equivalent weight polyol preferably is a polyether having terminal hydroxyl, primary amino and/or secondary amino groups, a nominal functionality of 2 to 3 and an actual functionality in the range of 1.8 to 3.0. The “nominal” functionality is the number of functional groups expected to be present on the polyol based on the composition of the starting materials. The actual functionality is sometimes somewhat lower, especially with polyether polyols which tend to contain some terminal unsaturation that reduces average functionality somewhat.

The additional high equivalent weight material may be a polymer of ethylene oxide, propylene oxide, tetrahydrofuran or butylene oxide, or a mixture of two or more of these. Particularly suitable polyether polyols include polymers of propylene oxide, random copolymers of propylene oxide and ethylene oxide, especially those containing up to about 15% by weight randomly polymerized ethylene oxide, and oxyethylene-capped polymers of propylene oxide or propylene oxide-ethylene oxide random copolymers. These polyols are conveniently prepared by adding the corresponding alkylene oxide to an initiator material such as a low molecular weight compound containing two or more hydroxyl and/or primary or secondary amine groups. Some or all of the terminal hydroxyl groups can be converted to amino groups, through a reductive amination process or by capping the polyol with a diisocyanate and then hydrolyzing the resulting terminal isocyanate groups to form primary amino groups. Amine-terminated polyethers are commercially available from Huntsman Chemicals under the tradename Jeffamine®.

The additional high equivalent weight material, if present, may constitute from about 1 to about 60% of the total weight of the high equivalent weight materials in the polyol composition. Preferably, it will constitute about 20-50% by weight of the high equivalent weight isocyanate-reactive materials.

The polyol component includes at least one chain extender. For purposes of this invention, a chain extender is a material having two isocyanate-reactive groups/molecule and an equivalent weight per isocyanate-reactive group of from about 30 to 150. Hydroxyl-containing chain extenders are generally less preferred as they tend to react more slowly with isocyanate groups than do primary or second amino groups. Examples of suitable hydroxyl-terminated chain extenders include ethylene glycol, diethylene glycol, triethylene glycol, propylene glycol, dipropylene glycol, tripropylene glycol, 1,4-dimethylolcyclohexane, 1,4-butane diol, 1,6-hexane diol and 1,3-propane diol. Chain extenders having two primary amino groups can be used. These include, for example, amino ethyl piperazine, 2-methyl piperazine, 1,5-diamino-3-methyl-pentane, isophorone diamine, ethylene diamine, hexane diamine, hydrazine, piperazine, mixtures thereof and the like. Chain extenders having two aromatic primary or secondary amino groups are more preferred. Especially preferred chain extenders are aromatic diamines which are substituted in at least one and preferably both ring positions alpha to each amino group. Examples of this last type include 1-methyl-3,5-diethyl-2,4-diaminobenzene, 1-methyl-3,5-diethyl-2,6-diaminobenzene, 1,3,5-trimethyl-2,4-diaminobenzene, 1-methyl-5-t-butyl-2,4-diaminobenzene, 1,3,5-triethyl-2,4-diaminobenzene, 1-methyl-5-t-butyl-2,6-diaminobenzene, 3,5,3′,5′-tetraisopropyl-4,4′-10 diaminodiphenylmethane, 3,5-diethyl-3′5′-diisopropyl-4,4′-diaminodiphenylmethane, 3,3′-diethyl-5,5′-diisopropyl-4,4′-diaminodiphenylmethane, 1-methyl-2,5-diamino-4-isopropylbenzene and mixtures of two or more thereof. Most preferred are 1-methyl3,5-diethyl-2,4-diaminobenzene, 1-methyl-3,5-diethyl-2,6-diaminobenzene, and mixtures thereof.

The amount of the chain extender can be varied, depending on the desired physical properties of the product polymer. Higher chain extender levels tend to increase properties like tensile modulus and tensile strength while reducing elongation. Chain extenders advantageously constitute from 5% up to about 50% of the combined weight of all isocyanate-reactive materials in the polyol component. A preferred amount is from 10 to 45% and a more preferred amount is from 15 to 40%. In some cases, it has been found that the chain extender level can be reduced somewhat when the hydroxymethylated polyester is used in accordance with this invention, while maintaining an equivalent final polymer tensile modulus, compared to the case in which a polyether polyol constitutes the entire amount of the high equivalent weight material.

The polyisocyanate component includes at least one organic polyisocyanate, which may be an aromatic, cycloaliphatic, or aliphatic isocyanate. Examples of suitable polyisocyanates include m-phenylene diisocyanate, toluene-2-4-diisocyanate, toluene-2-6-diisocyanate, hexamethylene-1,6-diisocyanate, tetramethylene-1,4-diisocyanate, cyclohexane-1,4-diisocyanate, hexahydrotoluene diisocyanate, naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, a polymethylene polyphenylisocyanate (PMDI), toluene-2,4,6-triisocyanate and 4,4′-dimethyldiphenylmethane-2,2′,5,5′-tetraisocyanate. Diphenylmethane-4,4′-diisocyanate, diphenylmethane-2,4′-diisocyanate and mixtures thereof are generically referred to as MDI, and all can be used. Preferably the polyisocyanate is diphenylmethane-4,4′-diisocyanate, diphenylmethane-2,4′-diisocyanate, PMDI, a biuret-modified “liquid MDI” product, or mixtures thereof. Polyisocyanate compounds or mixtures thereof having from about 1.8 to about 2.5 isocyanate groups/molecule, on average, are preferred, especially those having an average of about 1.9 to about 2.3 isocyanate-groups/molecule.

The polyisocyanate component may include or consist of a prepolymer formed in the reaction of a stoichiometric excess of any of the foregoing polyisocyanates with an isocyanate-reactive compound. The isocyanate-reactive compound may be a material having an equivalent weight per isocyanate group of about 200 or less, especially about 150 or less. In such a case, the prepolymer is often referred to as a “hard segment” prepolymer.

Alternatively, the isocyanate-reactive compound used to make the prepolymer may be a material having an equivalent weight of 500 or more, in which case the prepolymer is known as a “soft segment” prepolymer.

Additional, optional materials may be used to make the polymer. One preferred additional material is a polymerization catalyst. The polyurethane-forming composition also preferably contains one or more catalysts, which promote the reaction of the polyisocyanate with the isocyanate-reactive materials. Suitable catalysts include tertiary amines, organometallic compounds, or mixtures thereof. Specific examples of these include di-n-butyl tin bis(mercaptoacetic acid isooctyl ester), dimethyltin dilaurate, dibutyltin dilaurate, dibutyltin diacetate, dibutyltin sulfide, stannous octoate, lead octoate, ferric acetylacetonate, bismuth carboxylates, triethylenediamine, N-methyl morpholine, like compounds and mixtures thereof. An organometallic catalyst can be employed in an amount from about 0.01 to about 0.5 parts per 100 parts of the combined weight of the polyol and polyisocyanate components. A tertiary amine catalyst is suitably employed in an amount of from about 0.01 to about 3 parts per 100 parts by weight of the combined weight of the polyol and polyisocyanate components. An amine type catalyst and an organometallic catalyst can be employed in combination. Catalysts are typically blended into the polyol component.

Another preferred optional material is an internal mold release agent. Several types can be used, including metal carboxylate (especially zinc carboxylate/aliphatic amine mixtures, as described in U.S. Pat. Nos. 4,876,109, 4,895,879, 5,008,033, 5,011,647, 5,043,384, 5,045,591 and 5,051,466; zinc carboxylate/fatty acid ester types as described in U.S. Pat. No. 4,868,224; mixed ester types such as described in U.S. Pat. No. 5,389,696; and fatty acid condensation product/petroleum oil types as described in U.S. Pat. No. 7,195,726. The preferred type of internal mold release agent is a mixture of an aliphatic amine and a zinc carboxylate. One preferred aliphatic amine is an aminated polyether, in which from about 60 to 100% of the hydroxyl groups on the polyether polyol starting material have been converted to primary amino groups. The aminated polyether may have a molecular weight of from about 200 to about 5000, and preferably has an average of from 2 to 4 amino and hydroxyl groups combined per molecule. Another preferred type of aliphatic amine is an amine-initiated polyether, which may have a molecular weight of from about 200 to about 5000 and preferably contains from 2 to 4 hydroxyl groups per molecule. Note that if an aminated polyether or amine-initiated polyether has an equivalent weight of 500 or more, it counts as a high equivalent weight material, and its presence should be factored into the calculation of the proportion of hydroxymethyl-containing polyester that is used herein.

The internal mold release composition is in most cases blended into the polyol component, but may be blended into the polyisocyanate component if it is not reactive towards isocyanate groups.

Another preferred additional component is a surfactant. Silicone surfactants are generally preferred types. When a cellular or microcellular polymer is produced, the surfactant helps to produce a stable, uniform cell structure. Surfactants are typically used in amounts of 2% or less by weight of the combined weight of the polyol component and the polyisocyanate component.

A crosslinker may be included in the polyol composition. A crosslinker, for purposes of this invention, is a compound having three or more isocyanate reactive groups and an equivalent weight per isocyanate-reactive group of 150 or less. The use of a crosslinker may help to increase “green strength”, i.e. the strength of the polymer when it has cured sufficiently to be removed from the mold, but before it is fully cured and has fully developed its physical properties. The isocyanate-reactive groups contained on a crosslinker may be hydroxyl, primary amine or secondary amine groups.

Aminoalcohols and amine-initiated polyols are particularly useful types of crosslinkers. Crosslinkers may constitute up to 10% by weight of the polyol component, preferably up to about 5% by weight and more preferably up to about 2% by weight.

It is often desirable to produce a reinforced or filled polymer. In some cases, reinforcements (particularly fiber reinforcements) can be positioned within the mold prior to injecting the polyurethane-forming composition. In such a case, the injected composition flows between the individual particles and fibers, fills the mold, and is cured to form a reinforced composite. Particulate fillers are preferably blended in with either or both of the polyol component and the polyisocyanate component. Suitable fillers include glass (such as flaked glass or glass fibers); minerals such as talc, boron nitride montmorillonite, marble, granite, calcium carbonate, aluminum trihydrate, silica, silica-alumina, zirconia, talc, bentonite, antimony trioxide, kaolin, wollastonite, mica, titanium dioxide and the like; metal flakes, fibers or particles; carbon fibers; expanded graphite, high-melting polymers such as aramid fibers; coal based fly ash and the like. Fillers typically constitute from about 3 to about 30, preferably from about 5 to about 20 weight percent of the polymer product, depending on the dimensional and stiffness requirements of the end application.

It is possible to use a blowing agent in this invention if it is desired to reduce the density of the polymer. However, preferred embodiments of the invention are either noncellular or microcellular, in which cases little or no blowing agent is used. “Microcellular” in this context means that the density of the polymer is reduced by no more than about 20%, preferably by no more than 10%, due to the formation of a cellular structure. Microcellular polymers are preferably formed in this invention by “nucleating” either or both of the starting components by mixing them with pressurized gas such as air or nitrogen. The nucleation entrains a small quantity of gas, which allows the composition to expand slightly when introduced into the mold. This small amount of expansion helps the composition to fill the mold completely. Nucleation typically does not result in a significant decrease in the density of the polymer. The density of the part preferably is at least 0.6 g/cc and more preferably is at least 0.95 g/cc. The presence of fillers or reinforcing agents can cause the density to be somewhat higher. Typically, the density is not about 1.5 g/cc and more typically is not about 1.25 g/cc.

Other additives that may be used include fire retardants, pigments, antistatic agents, reinforcing fibers, antioxidants, preservatives, acid scavengers, and the like.

A polymer is formed in accordance with the invention by mixing the formulated polyol component with the polyisocyanate component, transferring the mixture to a closed mold and then curing the mixture in the mold to form a cured polyurethane and/or polyurea polymer.

The mixing and transferring steps are performed via a reaction injection molding (RIM) process. In the RIM process, the polyol component and the polyisocyanate component are brought together under conditions of high shear, such that they are mixed together very rapidly and transferred almost immediately into the mold. The mixing is generally performed using a high pressure impingement mixing device. Further mixing can be performed by passing the mixture through a static mixing device as it is transferred to the mold. The use of high pressure mixing generally results in very rapid rates of mold filling. These are typically on the order of from 0.5 to 10 seconds, especially from 0.5 to 5 seconds and often from 0.5 to 2.5 seconds from the time the polyol and polyisocyanate compounds are first contacted, depending somewhat on the size of the mold cavity.

The ratio of polyol component to polyisocyanate component is generally selected to provide an isocyanate index of at least 80, preferably at least 95 and more preferably at least 100. “Isocyanate index” refers to 100 times the ratio of isocyanate groups to isocyanate-reactive groups contains in the reaction mixture. The isocyanate index is generally no higher than 150, and is preferably no higher than 125. An especially preferred isocyanate index is from 105 to 120.

As the RIM process is generally designed for short cycle times, it is usually desirable to pre-heat the mold, so as to drive the cure. Demolding is generally done as soon as the polymer has cured enough that it can be demolded without permanent deformation. The demold time, measured from the time the polyol and isocyanate components are first contacted, is generally no more than two minutes. The demold time is more usually no more than one minute when amine chain extenders are used, and in such cases are most typically more typically no more than 30 seconds.

The demolded part often has not achieved its fully developed physical properties. For this reason, the parts are often post-demold cured to develop those properties. Post-demold curing can occur as the part cools. Alternatively, the part can be post-cured by maintaining it at a somewhat elevated temperature, sufficient to promote additional curing but not so high as to cause significant thermal degradation of the polymer. The part can also be postcured using infrared radiation, as described in U.S. Pat. No. 6,552,100.

The process of the invention is useful for preparing a wide range of polyurethane and/or polyurea molded parts. The parts are preferably noncellular or microcellular, as described before. The RIM process is particularly suitable for the production of parts that are large or must have high quality surfaces. In those cases, the molds tend to be expensive and short cycle times are needed to produce parts economically.

Vehicular (cars, trucks, trains, aircraft and other vehicles) body panels, claddings and automotive fascia are parts that are of particular interest. These parts are often painted, and often the painted parts must have a glossy, high distinctness-of-image surface.

The following examples are provided to illustrate the invention but are not intended to limit the scope thereof. All parts and percentages are by weight unless otherwise indicated. Unless stated otherwise, all molecular weights expressed herein are weight average molecular weight.

### EXAMPLES

The following materials are employed in these examples:

Hydroxymethyl containing polyester polyol A (HMPP A) is the reaction product of a ˜625 molecular weight trifuntional poly(propylene oxide) and a hydroxymethylated soybean oil. HMPP A has a functionality of about 3.0 hydroxyl groups per molecule and a hydroxyl equivalent weight of about 625.

Polyether Polyol A is a ˜5000 molecular weight, nominally trifunctional ethylene oxide-capped poly(propylene oxide). It is available from The Dow Chemical Company as XUS 14003.01 polyol.

Polyether Polyol B is an adduct of propylene oxide and ethylene diamine. It is available from The Dow Chemical Company under the tradename Voranol® 640.

DETDA is a mixture of 1-methyl-3,5-diethyl-2,4-diaminobenzene and 1-methyl, 3,5-diethyl-2,6-diaminobenzene.

Tin Catalyst A is an organotin catalyst available from Witco Corporation as Fomrez™ UL-28.

IMR A is a blend of zinc stearate with aliphatic amines.

Polyisocyanate A is a 181 equivalent weight hard segment MDI prepolymer, available from The Dow Chemical Company as Isonate® 181.

### Examples 1-9 and Comparative Sample A

A series of RIM elastomers is prepared using the formulations described in Table 1 below. The formulations are process by combining all ingredients except the polyisocyanate to form a formulated polyol component. The formulated polyol component is heated to about 42° C. and nucleated with nitrogen. The polyisocyanate is separately heated to about 40° C. The formulated polyol component and the polyisocyanate are mixed and injected into a 3.5 mm thick plaque mold (preheated to 70° C.), using a Linden injection unit coupled to an Admiral 250 ton press. Demold time is 25 seconds.

The demolded plaques are postcured for one hour at 135° C., and then tested for heat sag according to ASTM 3769, Izod impact strength at 23° C. according to ISO 180, tensile strength, tensile modulus and elongation according to ISO 522, and flexural modulus according to ISO 178. Results are as indicated in Table 1.

TABLE 1

| | Example No. | | | | | | | | | |
|---|---|---|---|---|---|---|---|---|---|---|
| | A* | 1 | 2 | 3 | 4 | 5 | 6 | 7 | 8 | 9 |
| HMPP A, pbw | 0 | 38.78 | 62.04 | 66.24 | 67.44 | 68.44 | 81.8 | 79.8 | 81.8 | 79.8 |
| Polyether Polyol A, pbw | 77.55 | 38.78 | 15.15 | 16.31 | 16.2 | 17.11 | 0 | 0 | 0 | 0 |
| % HMPP | 0 | 50 | 80 | 80 | 80 | 80 | 100 | 100 | 100 | 100 |
| DETDA, pbw | 16.25 | 16.25 | 16.25 | 12.25 | 10.16 | 8.25 | 15 | 13.5 | 12 | 12 |
| IMR, pbw | 6 | 6 | 6 | 6 | 6 | 6 | 6 | 6 | 6 | 6 |
| Polyether Polyol B, pbw | 0 | 0 | 0 | 0 | 0 | 0 | 0 | 0.5 | 0 | 2 |
| Tin Catalyst A, pbw | 0.1 | 0.1 | 0.1 | 0.1 | 0.1 | 0.1 | 0.1 | 0.1 | 0.1 | 0.1 |
| Wollastonite (% of total | 7.88 | 8.48 | 8.48 | 6.67 | 7.33 | 7.25 | 7.65 | 13.09 | 8.18 | 8.19 |
| polymer weight) | | | | | | | | | | |
| Polyisocyanate A, to index | 106 | 106 | 106 | 106 | 106 | 106 | 106 | 106 | 106 | 106 |
| Heat Sag, mm | 3.8 | 2.8 | 2.1 | 4.2 | 18.5 | 22.6 | ND | 10.1 | 12.5 | 15.5 |
| Izod Impact, ft-lb/in (J/cm) | 5.4 (2.9) | 3.4 (1.8) | 2.7 (1.4) | 3.5 (1.9) | 3.8 (2.0) | 3.6 (1.9) | 2.6 (1.4) | 2.5 (1.3) | 2.5 (1.3) | 2.4 (1.3) |
| Elongation to Break, % | 208 | 122 | 102 | 108 | 87 | 82 | 72 | 86 | 83 | 81 |
| Tensile Modulus, MPa | 317 | 410 | 622 | 26 | 138 | 72 | 66 | 50 | 97 | 45 |
| Tensile Strength, MPa | 21.1 | 22.3 | 24.6 | 19.6 | 15.0 | 10.4 | N.D. | 21.6 | 12.5 | 19.2 |
| Flexural Modulus, MPa | 344 | 478 | 659 | 408 | 270 | 134 | 465 | 453 | 364 | 387 |

*Not an example of the invention.
N.D. is not determined.

From the foregoing, it will be observed that numerous variations and modifications may be effected without departing from the true spirit and scope of the novel concepts of the invention.

1. A reaction injection molding process comprising mixing a formulated polyol component with a polyisocyanate component, transferring the mixture to a closed mold and then curing the mixture in the mold to form a cured polyurethane and/or polyurea polymer, wherein the polyol component includes (1) at least one high equivalent weight material having at least 1.8 isocyanate-reactive groups per molecule and (2) at least one chain extender and further wherein at least 40% by weight of the high equivalent weight material is a hydroxymethylated polyester.

2. The process of claim 1, wherein the hydroxymethylated polyester is a mixture of compounds having the following average structure:
[H—X]_{(z-p)}—R—[X—Z]ₚ (I)
wherein R is the residue of an initiator compound having z hydroxyl and/or primary or secondary amine groups, where z is at least two; each X is independently —O—, —NH— or —NR′— in which R′ is an inertly substituted alkyl, aryl, cycloalkyl, or aralkyl group, p is a number from 1 to z representing the average number of [X—Z] groups per hydroxymethyl-containing polyester polyol molecule, Z is a linear or branched chain containing one or more A groups, provided that the average number of A groups per molecule is ≧1.3 times z, and each A is independently selected from the group consisting of A1, A2, A3, A4 and A5, provided that at least some A groups are A1, A2 or A3, wherein A1 is: 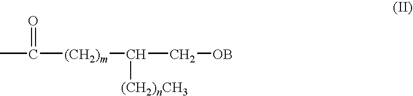
wherein B is H or a covalent bond to a carbonyl carbon atom of another A group; m is number greater than 3, n is greater than or equal to zero and m+n is from 8 to 22, especially from 11 to 19, A2 is: 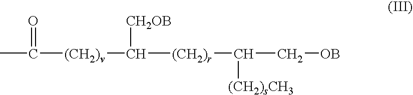
wherein B is as before, v is a number greater than 3, r and s are each numbers greater than or equal to zero with v+r+s being from 6 to 20, especially 10 to 18, A3 is: 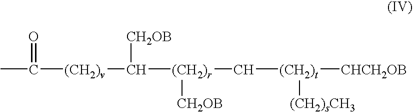
wherein B, v, each r and s are as defined before, t is a number greater than or equal to zero, and the sum of v, r, s and t is from 5 to 18, especially from 10 to 18, A4 is 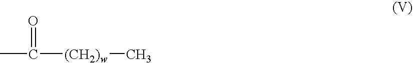
where w is from 10-24, and A5 is 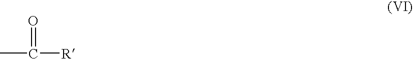
wherein R′ is a linear or branched alkyl group that is substituted with at least one cyclic ether group and optionally one or more hydroxyl groups or other ether groups.

3. The process of claim 2 wherein the hydroxymethylated polyester constitutes at least 50% by weight of the high equivalent weight material.

4. The process of claim 1 wherein the polyol component includes at least one chain extender containing primary amino groups.

5. The process of claim 1 wherein the polyol component or the polyisocyanate component, or both, contains an internal mold release additive.

6. The process of claim 5 wherein the internal mold release additive includes a zinc carboxylate and at least one of an amine-initiated polyether and an amine-terminated polyether.

7. The process of claim 1 wherein the formulated polyol component and polyisocyanate component are mixed via impingement mixing.

8. The process of claim 7, wherein the mold is filled within 10 seconds from the time the formulated polyol component and polyisocyanate component are first contacted with each other.

9. The process of claim 7, wherein the mold is filled within 5 seconds from the time the formulated polyol component and polyisocyanate component are first contacted with each other.

10. The process of claim 8, wherein the cured polyurethane and/or polyurea polymer is demolded within one minute from the time the formulated polyol component and polyisocyanate component are first contacted with each other.

11. The process of claim 1, wherein the cured polyurethane and/or polyurea polymer has a density of at least 0.95 g/cm³.

12. The process of claim 1, wherein either or both of the formulated polyol component or the polyisocyanate component is nucleated by mixing with a pressurized gas.

13. The process of claim 1, further comprising demolding the polyurethane and/or polyurea polymer and post-curing the demolded polyurethane and/or polyurea polymer.

14. The process of claim 13, further comprising painting the demolded polyurethane and/or polyurea polymer.
